(19) United States
(12) Patent Application Publication
(10) Pub. No.: US 2026/0119355 A1
(43) Pub. Date: Apr. 30, 2026

(54) ARTIFICIAL INTELLIGENCE EMULATION SYSTEM TO PROVIDE A RESPONSE TO AN INPUT BASED ON A CURRENT STATE OF A SYSTEM

(71) Applicant: Valent Holdings, LLC, Greeley, CO (US)

(72) Inventor: Schuyler J. Thompson, Greeley, CO (US)

(21) Appl. No.: 18/932,027

(22) Filed: Oct. 30, 2024

(51) Int. Cl. G06F 11/30; G06F 11/34

(52) U.S. Cl. CPC G06F 11/3058; G06F 11/3438

(57) ABSTRACT

Disclosed are novel tools and techniques for implementing a method to generate natural language responses to one or more inputs based on the system's current state. In one embodiment, a computing system receives an input, identifies external data related to the user's environment, controllable data from that environment, and user-specific data. The system correlates these data with predefined potential responses, determines an appropriate response based on this correlation, and replies to the input using a modular vocabulary database. This approach ensures that the natural language response mimics advanced AI and human emotion while remaining customizable to the user and is deterministic.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing an artificial intelligence emulation system to provide a response to an input based on a current state of a system.

### BACKGROUND

Artificial intelligence (AI) systems are non-deterministic, i.e., one cannot be certain the system will behave in a repeatable, reliable fashion. Because AI systems are non-deterministic, users cannot be sure of the responses the AI systems will generate, what exact data is processed by the AI systems, or other similar issues. Additionally, the AI systems are prone to mistakes or “hallucinations” (e.g., generating non-factual data but presenting it as factual, responding to an input in an unpredictable way, or the like). Further, AI systems are impersonal and typically cannot be customized to a particular user.

Hence, there is a need for more robust and scalable solutions for implementing systems that emulate AI while providing reliable or consistent responses, and, more particularly, to methods, systems, and apparatuses for implementing an artificial intelligence emulation system to provide a response to one or more inputs based on a current state of a system.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram of an exemplary system for implementing an artificial intelligence emulation system to determine a response to provide to one or more inputs, in accordance with various embodiments.

FIG. 2 is a schematic diagram of the system of FIG. 1 using different data sources to determine the response to use to respond to one or more inputs, in accordance with various embodiments.

FIGS. 3A and 3B are graphs that show a current state in a three-dimensional field, and how that state is correlated to available response options to find the nearest response option.

FIG. 4A depicts an example formula used to corelate a current state and available response options in the 3D field.

FIGS. 4B-4D are example equations that programmatically show where in the 3D field the current state and the available response options exist in relation to each other.

FIG. 5 is a flow diagram for determining temperament, exuberance, and affection values.

FIG. 6 is a flow diagram illustrating how to determine a response to provide to an input.

### DETAILED DESCRIPTION OF CERTAIN EMBODIMENTS

### Overview

Various embodiments provide tools and techniques for implementing systems that emulate AI while providing reliable or consistent responses, and, more particularly, methods, systems, and apparatuses are provided for implementing an artificial intelligence emulation system to provide a response to one or more inputs based on a current state of a system.

In various embodiments, a computing system might receive an input, obtain personality values from the database based on data associated with the user making the query, then determine a response to use to react or to respond to the input using the correlated personality values. For example, the personality values from the database can include at least one of external data associated with an environment of a user, controllable data associated with the environment of the user, or user data associated with the user.

The various embodiments provide advantages over conventional artificial intelligence systems. In particular, the embodiments provide mechanisms to respond to one or more inputs in a reliable and consistent way while still customizing responses to use to react to or to respond to a particular user and while also still providing less-predictable responses. In a non-limiting example, the methods, computing systems, and apparatuses described herein are deterministic and function-based on one or more rules as defined by one or more users, customers, developers, programmers, or the like. Different data, information, factors or the like are correlated together to create a simulated personality, used to respond to one or more inputs and provide a customized experience to a user or multiple users. In this way, the methods, computing systems, and apparatuses described herein are prevented from hallucinating or generating false or non-factual information or responding to a user in an inaccurate way.

These and other features and advantages of the various embodiments are described in detail below with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, or computer systems, represent tangible, concrete improvements to existing technological areas, including, without limitation, AI technology, communication technology, or the like. In other aspects, certain embodiments can improve the functioning of user equipment or systems themselves (e.g., customer premises equipment, AI systems, communication systems, etc.). For example, by correlating, with the computing system, one or more of external data, controllable data, and user data; determining, with the computing system, a response to the input based on the correlation of two or more of external data, controllable data, and user data; and responding, with the computing system, to the input using the determined response. In particular, to the extent any abstract concepts are present in the various embodiments, those concepts can be implemented as described herein by devices, software, systems, and methods that involve specific novel functionality (e.g., steps or operations), such as, correlating, with the computing system, one or more of external data, controllable data, and user data; determining, with the computing system, a response to the input based on the correlation of two or more of external data, controllable data, and user data; and responding, with the computing system, to the input using the determined response, or the like, to name a few examples, that extend beyond mere conventional computer processing operations. These functionalities can produce tangible results outside of the implementing computer system, including, merely by way of example, by providing customizable deterministic responses to one or more inputs and determining a natural response to the one or more inputs in a reliable and consistent way.

In an aspect, a method might include receiving, with a computing system, an input; determining, with the computing system, external data associated with an environment of a user; determining, with the computing system, controllable data associated with the environment of the user; determining, with the computing system, user data associated with the user; correlating, with the computing system, the external data, the controllable data, and the user data with one or more predefined responses; determining, with the computing system, a response to the input based on the correlation of the external data, the controllable data, and the user data with the one or more predefined responses; and responding, with the computing system, to the input using the response.

In some embodiments, correlating, with the computing system, the external data, the controllable data, and the user data with the one or more predefined responses comprises assigning, with the computing system, the external data, the controllable data, and the user data to a first location in a space; and assigning, with the computing system, the one or more predefined responses to a corresponding location in the space. In some cases, determining the response to the input based on the correlation of the external data, the controllable data, and the user data with the one or more predefined responses comprises selecting, with the computing system, the response having the corresponding location located closest to the first location associated with the external data, the controllable data, and the user data in the space.

In some instances, the space is a three-dimensional space, and the external data is associated with a first axis, the controllable data is associated with a second axis, and the user data is associated with a third axis in the three-dimensional space.

In various cases, the external data comprises at least one of weather of the environment, temperature of the environment, humidity of the environment, air quality of the environment, time of day, day of week, time of year, or season of year, the controllable data comprises at least one of a first state of one or more devices within the environment or a second state of the user or other people, and the user data comprises user settings or user activity.

In some embodiments, at least one of the external data, the controllable data, or the user data is configured to change over time. In some cases, the external data is configured to change based on the environment of the user over time, the controllable data is configured to change based on the environment of the user over time, and the user data is configured to change based on user preferences over time or user activity over time.

In various instances, correlating the external data, the controllable data, and the user data with the one or more predefined responses comprises generating a relationship between each of the external data, the controllable data, and the user data. In some cases, generating the relationship between each of the external data, the controllable data, and the user data comprises determining, with the computing system, a first value of the external data based in part on at least one of the controllable data or the user data; determining, with the computing system, a second value of the controllable data based in part on at least one of the external data or the user data; and determining, with the computing system, a third value of the user data based in part on at least one of the external data or the controllable data. In some cases, the first value, the second value, and the third value are configured to change over a predetermined amount of time. In various embodiments, the external data is configured to change based on the environment of the user over time, the controllable data is configured to change based on the environment of the user over time, and the user data is configured to change based on user preferences over time or user activity over time.

In some cases, at least one first source of one or more of the external data, the controllable data, and the user data is configured to have a different affect than at least one other source of one or more of the external data, the controllable data, and the user data.

In various embodiments, the computing system is a local computing system contained within a premises of the user or a vehicle of the user. In some instances, the one or more predefined responses to respond to the input are stored in a database.

In some cases, the external data is determined at a first predetermined time, after a first predetermined amount of time has passed, or upon detection that the external data has changed, the controllable data is determined at a second predetermined time, after a second predetermined amount of time has passed, or upon detection that the controllable data has changed, and the user data is determined when the input is received or when a user interaction is received.

In various instances, correlating the external data, the controllable data, and the user data with of the one or more predefined responses and determining a response to the input based on the correlation of the external data, the controllable data, and the user data with the one or more predefined responses is based on one or more rules stored in a database of the computing system.

In some embodiments, the one or more predefined responses are determined by the computing system querying a generative artificial intelligence system for example responses based on the input, and the computing system assigns each example response a corresponding location in a mathematical space. In some instances, the computing system updates the corresponding location of each example response over time based on feedback received regarding each response.

In another aspect, an apparatus might include at least one processor and a non-transitory computer readable medium communicatively coupled to the at least one processor. The non-transitory computer readable medium might have stored thereon computer software comprising a set of instructions that, when executed by the at least one processor, causes the apparatus to: receive an input; determine external data associated with an environment of a user; determine controllable data associated with the environment of the user; determine user data associated with the user; correlate the external data, the controllable data, and the user data with one or more predefined responses; determine a response to the input based on the correlation of the external data, the controllable data, and the user data with the one or more predefined responses; and respond to the input using a predefined response of the one or more predefined responses.

In some embodiments, correlating the external data, the controllable data, and the user data with the one or more predefined responses comprises assigning the external data, the controllable data, and the user data to a first location in a space; and assigning the one or more predefined responses to a corresponding location in the space. In some cases, determining the response to the input based on the correlation of the external data, the controllable data, and the user data with the one or more predefined responses comprises selecting the response having the corresponding location located closest to the first location associated with the external data, the controllable data, and the user data in the space.

In yet another aspect, a system might include at least one of one or more sensors or one or more user devices, at least one processor, and a non-transitory computer readable medium communicatively coupled to the at least one processor. The non-transitory computer readable medium might have stored thereon computer software comprising a set of instructions that, when executed by the at least one processor, causes the computing system to: receive an input from at least one of the one or more sensors or the one or more user devices; determine external data associated with an environment of a user; determine controllable data associated with the environment of the user; determine user data associated with the user; correlate the external data, the controllable data, and the user data with one or more predefined responses; determine a response to the input based on the correlation of the external data, the controllable data, and the user data with the one or more predefined responses; and respond to the input using a predefined response of the one or more predefined responses

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

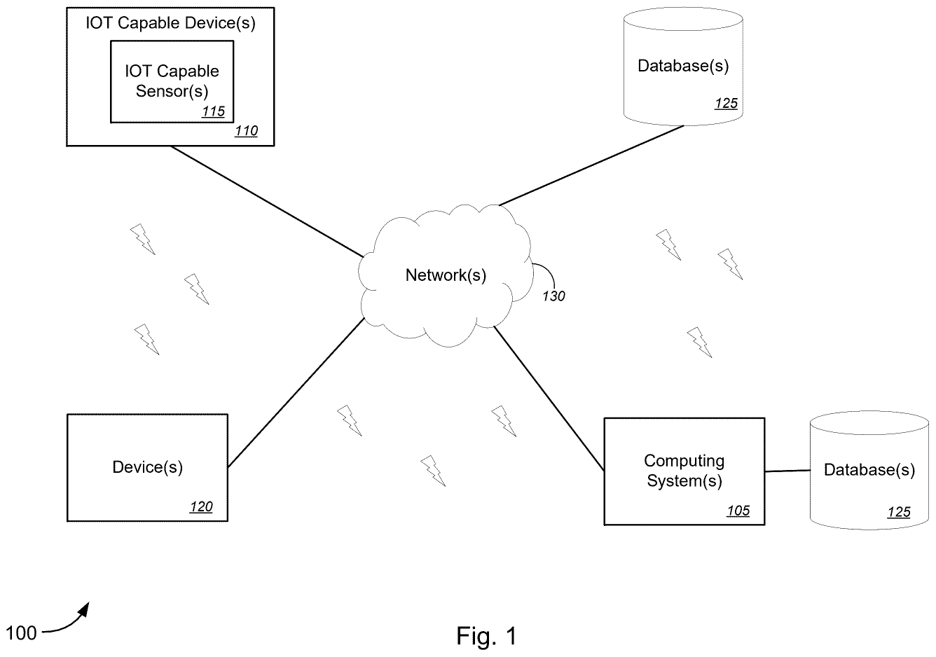

We now turn to the embodiments as illustrated by the drawings. FIGS. 1-6 illustrate some of the features of the method, system, and apparatus for implementing an AI emulation system, and, more particularly, to methods, systems, and apparatuses for implementing an AI emulation system to determine a response to use to react to or respond to one or more inputs, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

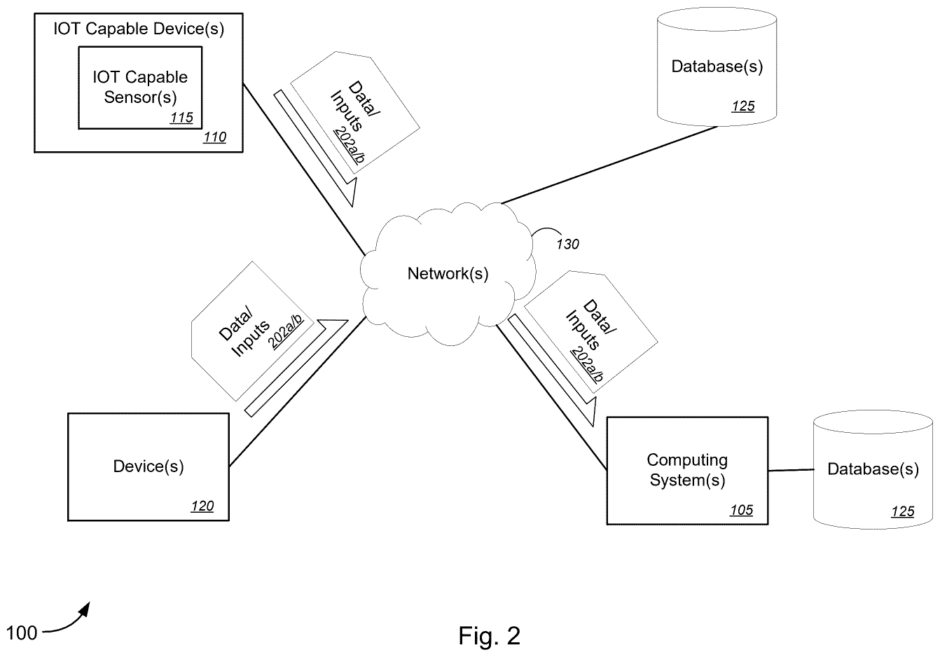

With reference to the figures, FIGS. 1 and 2 are schematic diagrams illustrating a system 100 for implementing an AI emulation system, in accordance with various embodiments. FIG. 2 represents data or inputs 202 that can be transmitted or received between different devices of computing system 100 to determine a response to the one or more inputs.

In FIGS. 1 and 2, system 100 might comprise one or more computing systems 105 and one or more databases 125 and could include one or more IoT-capable devices 110 or other devices, one or more IoT-capable sensors or other sensors 115, one or more devices 120, and one or more databases 125.

In some cases, system 100 can be fully contained within a premises or a vehicle of a user. The premises could include a house, an office building, a warehouse, a commercial building, a hotel, an apartment, a townhouse, or the like. The vehicle could include, without limitation, a motorcycle, a car, a truck, a camper, a bus, an emergency vehicle, or the like. A user could include a user of the system 100, a customer, or another person, etc. By fully containing system 100 within the premises or vehicle of the user, each of the computing systems 105, one or more IoT-capable devices 110 or other devices, one or more IoT-capable sensors or other sensors, one or more devices 120, and one or more databases 125 are fully local to a user and a user's privacy and data can be protected.

In some cases, components of system 100 can further be included in a single computing device within a premises or vehicle of the user. In a non-limiting example, the single computing device could include or be integrated into a single physical unit with one or more of computing systems 105 and one or more databases 125, and potentially further include one or more IoT-capable devices 110 or other devices, one or more IoT-capable sensors or other sensors, one or more devices 120. In some cases, the computing device can have an onboard database (e.g., database 125), one or more IoT sensors or devices, or other devices. By including one or more components as a single physical unit such as the single computing device and the database 125, these components do not need to be connected by a network (e.g., network 130 or the like) to communicate and are, therefore, better able to protect user data and less likely to be compromised, such as in reverse engineering, from a cyberattack, or from malware.

In other cases, one or more components (e.g., one or more databases 125 or the like) could be remote from the premises or the vehicle while other components (e.g., one or more computing systems 105, one or more IoT-capable devices 110 or other devices, one or more IoT-capable sensors or other sensors, one or more devices 120, or the like) can be local to the premises or vehicle. By having the one or more databases 125 be remote from the user premises, the one or more databases may be more easily updated by a manufacturer, programmer, business, etc., may be configured to store more data, or the like. Additionally, by having one or more components remote from the premises or vehicle, a manufacturer, programmer, business, etc. may be able to provide immediate remote support to a user of the system.

In various cases, the one or more computing systems 105 might comprise at least one local computing system 105. The local computing system 105 might be local to the premises or the vehicle in which the one or more IoT-capable devices 110, the one or more IoT-capable sensors 115, the one or more devices 120, or the one or more databases 125 are disposed. The local computing system 105 might be isolated from or prevented from connecting to the Internet or network 130. By keeping local computing system 105 isolated from the Internet or network 130, it is easier to protect user data and computing system 105 is less likely to be compromised, such as in reverse engineering, a cyberattack or from malware.

The one or more computing systems 105 might alternatively or additionally comprise at least one remote computing system 105 that is remote from the one or more of the at least one IoT-capable device 110, the at least one IoT-capable sensor 115, the at least one device 120, or the premises or vehicle in which the one or more of the at least one IoT-capable device 110, the at least one IoT-capable sensor 115, the at least one device 120, or the one or more databases 125 are disposed. The at least one remote computing system 105 or local computing system 105 might be accessible by any of the IoT-capable devices 110, the IoT-capable sensors 115, the devices 120, or the databases 125 or the like via one or more networks 130.

In some cases, the one or more computing systems 105 might include, but are not limited to, at least one of an IoT human interface device (e.g., a Raspberry Pi, a computer, a laptop, a phone, or a single processor or a plurality of processors disposed therein, whereas, such processor or processors may be physical or virtual in nature), a vehicle node or hub, a central node or hub, a computing node or hub, an IoT management node or hub, a distributed computing system that integrates computing resources from two or more of the one or more IoT-capable devices 110, the one or more IoT-capable sensors 115, the one or more devices 120, or the one or more databases 125, or the like.

According to some embodiments, the IoT-capable devices 110 might include, without limitation, at least one of a desktop computer, a laptop computer, a tablet computer, a smart phone, a mobile phone, a portable gaming device, a database or data storage device, a network access point (“NAP”), a television or monitor, a set-top box (“STB”), a gaming console, an image capture device, a video capture device, a time piece (including, without limitation, a clock, a watch, or other time piece, and the like), a thermostat or environmental control system, a kitchen appliance (including, but not limited to, a microwave oven, a refrigerator, an oven, a range, a stove, an induction cooktop, a pressure cooker, a rice cooker, a bread maker, a coffee machine, a kettle, a dishwasher, a food thermometer, or the like), a medical device, a telephone system, a media recording or playback device, a lighting system, a customer premises security control system, one or more dedicated remote control devices, one or more universal remote control devices, a personal digital assistant, a fitness tracking device, a printer, a scanner, an image projection device, a video projection device, a household appliance, a vehicle, an audio headset, earbuds, speakers, virtual reality goggles or headset, augmented reality goggles or headset, a door unlocking/locking system, an automated door opening/closing system, a window locking system, an automated window opening or closing system, an automated window covering control system, a smart window, a solar cell or solar cell array, an electrical outlet or smart node, a power strip or bar, a dimmer switch, a data port, a sprinkler system, exercise equipment, an array of one or more sensors, or the like. The IoT-capable devices 110, in some cases, might further include, but are not limited to, one or more of a furnace, an air conditioner, one or more automated skylight opening or closing systems, one or more humidifiers, one or more dehumidifiers one or more ventilation fans, one or more automated lawn mowers, one or more automated trimmers, one or more sprinkler systems, one or more fertilizer dispensers, one or more automated vacuum machines, one or more automated mopping machines, a washing machine, a clothes dryer, a custom peripheral, or any similar embodiment.

In some embodiments, the IoT-capable devices 110 might further include, without limitation, at least one of one or more vehicles, vehicle systems, or vehicular components in each of one or more vehicles (e.g., private vehicles, company vehicles, commercial, public transit vehicles, etc.) travelling on the roadway. These systems could include, but are not limited to, a vehicle computer, a vehicle engine, an electronic throttle control (“ETC”) system, a vehicle brake system, a vehicle gear system, a vehicle steering system, a vehicle light system (e.g., vehicle head light system, vehicle turn signal light system, vehicle brake light system, vehicle hazard light system, etc.), a vehicle (analog or digital) instrument gauge cluster, a navigation system, a vehicle diagnostic system, a vehicle-based transceiver or communications system, a vehicle-based wireless access point (“WAP”), a vehicle door unlocking/locking system, an automated vehicle door opening/closing system, an automated vehicle window opening or closing system, an automated vehicle window covering control system, one or more vehicle climate control systems, or the like.

In certain embodiments, the IoT-capable sensors 115 may be positioned inside, on the surface of, or partially embedded in each IoT-capable device 110, or may be separate from the IoT devices. These sensors may include, but are not limited to, one or more temperature sensors (e.g., heat sensors, infrared sensors, thermometers, etc.), one or more light sensors (e.g., ambient light sensors, luminosity sensors, illuminance sensors, solar light sensors, etc.), one or more humidity sensors (e.g., room humidity sensors, outdoor humidity sensors, etc.), one or more moisture sensors, one or more motion sensors, one or more cameras, one or more biometric sensors (e.g., fingerprint sensors, palm print sensors, footprint sensors, handprint sensors, voice identification sensors, iris scanners, retina scanners, etc.), one or more location sensors (e.g., global positioning system (“GPS”) devices, global navigation satellite system (“GNSS”) devices, other location sensors, etc.), one or more air quality sensors, one or more carbon monoxide sensors, one or more smoke detectors, one or more water leak detectors, one or more contact sensors (e.g., for building/vehicle door lock system, for building/vehicle moon/sky light ajar detector, for building/vehicle window open detector, for vehicle hood ajar detector, for vehicle trunk ajar detector, or the like), one or more audio sensors, one or more accelerometers, one or more proximity sensors, one or more seismic sensors, one or more radiation sensors, one or more telecommunications signal sensors or communications signal detectors, or the like.

According to some embodiments, the IoT-capable sensors 115 of a vehicle might further include, but are not limited to, at least one of one or more proximity sensors (e.g., vehicle camera-based collision avoidance system, the vehicle radar-based proximity detection system, the vehicle lidar-based proximity detection system, the vehicle sonar-based proximity detection system, etc.), one or more speed sensors, one or more fuel level sensors (e.g., gasoline tank level sensors, diesel tank level sensors, battery charge level sensors, etc.), one or more brake sensors, one or more fluid leak detectors, one or more tire pressure sensors, an engine temperature sensor, one or more fluid leak detectors, one or more occupant sensors, one or more impact sensors, one or more stress sensors, or one or more suspension system diagnostic sensors, or the like.

In some cases, the devices 120—which might be IoT-capable or might simply be controllable by an IoT-capable device 110 (or by the computing system 105), and might, for purposes of description herein, be a device that does not have any IoT-capable sensors 115 disposed therein or thereon—might include, without limitation, at least one of one or more conventional display devices, one or more conventional lights, one or more conventional furnaces, one or more conventional air conditioners, one or more conventional ventilation systems, one or more conventional sprinkler systems, one or more wireless electrical outlets, or the like.

In some embodiments, the database 125 can be used to store information regarding the one or more computing systems 105, information regarding the IoT-capable devices 110, information regarding the IoT-capable sensors 115, information regarding the devices 120, information regarding communications amongst these devices and sensors, information regarding communications between each user of the various devices and the computing system 105 or any of the IoT-capable devices and sensors, information regarding the network 130, information regarding communications between the computing systems 105 and each of the IoT-capable devices 110, the IoT-capable sensors 115, and the devices 120, or other information, or the like.

In some instances, the network 130 might include, without limitation, one of a fiber network, an Ethernet network, a Token-Ring™ network, a wide-area network (“WAN”), a wireless wide area network (“WWAN”), a local area network (LAN), a stand-alone or isolated network, a virtual private network (“VPN”), the Internet, an intranet, an extranet, a public switched telephone network (“PSTN”), an infra-red network, a wireless network operating under any of the IEEE 802.11 suite of protocols, a Bluetooth™ protocol, a Matter network, a Zigbee network, or any other wireless protocol, or any combination of these or other networks.

The machine-to-machine communications between the computing system 105, the IoT-capable devices 110, the IoT-capable sensors 115, the one or more devices 120, or the one or more databases 125 or the like can be over network 130 and can are represented in FIG. 1 by the lightning bolt symbols, which in some cases denote wireless communications (although, in some instances, need not be wireless, but can be wired communications). Herein, “machine-to-machine communications” refers to communications between or among machines or devices or machines to network 130 that are not initiated by or instructed by a human, but are rather initiated autonomously by one of the machines based on triggers (e.g., conditions being met; particular sensor data being received, observed, recorded, etc.; sensor data exceeding predetermined threshold levels for particular types of sensors; or the like).

In some cases, the computing system 105 can include an analytics engine and an associated database 125 that together analyze and track (or record or store) communications, inputs, or other data amongst the various components of system 100 (i.e., the one or more computing systems 105, the IoT-capable devices 110, the IoT-capable sensors 115, the devices 120, or the like) or user inputs to identify user inputs, device inputs, sensor inputs, trends or the like, the results of which might cause the one or more computing systems 105 to determine a response or notification to the one or more device inputs, user inputs. In this way, the computing system 105 can be configured to emulate an AI interface and provide a response to communications or inputs amongst the various components of system 100 or user inputs.

In various cases, the database 125 can include a database of responses to respond to the one or more user inputs, device inputs, sensor inputs, trends or the like. The database of responses can be created by a manufacturer, programmer, or the like. The database 125 of responses can be created using crowdsourcing or inputs from one or more users or third parties. In some cases, the database 125 of responses can be created, augmented, or maintained using generative artificial intelligence. In a non-limiting example, when the computing system 105 receives an input, the computing system 105 could query a generative artificial intelligence system to determine any potential additional or replacement responses to the input. The computing system 105 could then select the best response to use to respond to the input based on one or more methods described below.

In some cases, the database 125 can reflect a personality of responses to respond to the one or more user inputs, device inputs, sensor inputs, trends or the like. For example, the database 125 can be configured to have a “personality” that is dour and pessimistic and the responses included in database 125 can reflect that personality by being more negative, sad, less hopeful or the like. Alternatively, the database 125 can be configured to have a “personality” that is optimistic and the responses included in database 125 can reflect that personality by being more happy, cheerful, hopeful, or the like. Thus, the computing system 105 can respond to the one or more user inputs, device inputs, sensor inputs, trends or the like based on the personality assigned to the database. Many other personalities of database 125 are possible and within the scope of this disclosure. In some cases, the personality of the database 125 can change over time based on the one or more user inputs, device inputs, sensor inputs, trends, the environment of the user, the activity of the user, the preferences of the user, or the like.

FIGS. 2-4 depict different figures for how system 100 or computing system 105 can utilize the communications or inputs amongst the various components of system 100 or the user inputs to determine a response to the one or more inputs amongst the various components of system 100 or user inputs.

Turning to FIG. 2, FIG. 2 is a schematic diagram illustrating the system 100 for implementing the AI emulation system, in accordance with various embodiments. In FIG. 2, system 100 or computing system 105 could receive one or more inputs or data 202 from one or more of the one or more computing systems 105, one or more IoT-capable devices 110 or other devices, one or more IoT-capable sensors or other sensors, one or more devices 120, and one or more databases 125 or from a user of one or more computing systems 105, one or more IoT-capable devices 110 or other devices, one or more IoT-capable sensors or other sensors, one or more devices 120, and one or more databases 125. Alternatively, as discussed above one or more components of system 100 could be implemented in a single physical unit that is capable of receiving inputs 202.

The inputs or data 202 can include several different types of inputs or data. In a non-limiting example, the inputs or data 202 can be input by a user or can be received automatically from the one or more computing systems 105, one or more IoT-capable devices 110 or other devices, one or more IoT-capable sensors or other sensors, one or more devices 120, and one or more databases 125. The inputs or data 202 can be simple such as user input into a keyboard or complex such as multiple inputs from one or more systems or combinations of systems such as cars, airplanes, buildings, towns, weather services, or the like.

In various cases, the inputs or data 202 can be used by the computing system 105 to determine (1) whether the inputs or data 202a require a response or notification or (2) whether the inputs or data 202b can be used to determine a current state of the system 100 to use to respond to one or more other inputs or data 202a requiring a response or notification.

In some cases, the inputs or data 202a can include, without limitation, user input or data (e.g., voice input, keyboard input, user state data as discussed below, or the like), sensor or device input or data (e.g., IoT sensor or device input or data, sensor state as discussed below, device state as discussed below, or the like), or external input or data (e.g., data determined by external factors not controllable by a user as discussed below, or the like).

In some cases, the inputs or data 202b can include one or more of temperament data or external data (“T data”), exuberance data or controllable data (“E data”), or affection data or user data (“A data”). The one or more of T data, E data, or A data can be used by the system 100 to determine a current state of the system 100 and the current state of the system 100 can be used to determine, affect, or influence a response to one or more other inputs or data 202a requiring a response or notification. Although the terms temperament data or external data, exuberance data or controllable data, or affection data or user data are used throughout this application, other terms could be used to describe these different types of data and the application should not be limited to only these terms.

The T data can include, without limitation, data determined by external factors not controllable by a user. In a non-limiting example, T data can include, without limitation, at least one of weather of an environment, temperature of the environment, humidity of the environment, air quality of the environment, time of day, day of week, time of year, season of year, traffic along a route of a vehicle, or the like. In various cases, the environment could be an interior of a premises, an interior of a vehicle, an environment surrounding the premises or the vehicle, or the like.

The E data can include, without limitation, data determined by factors controllable or more controllable by a user of system 100. In a non-limiting example, the controllable inputs or data can include at least one of a state of one or more sensors devices within the environment or a state of the user or other people within the environment.

In a non-limiting example, a state of one or more sensors 115 or devices 110 or 120 within the environment can include, without limitation, a state of a sensor 115 (e.g., on, off, open, closed, etc.), a state (e.g., open, closed, locked, unlocked) of one or more windows or doors in the environment, a state (e.g., on or off) of one or more music systems, lights, televisions, appliances or the like of the environment, a state (e.g., in use or not in use) of exercise equipment within the environment, or the like. In various cases, the state can further include other information such as type (e.g., pop, country, jazz) of music that is playing, number of lights that are on or off, location of device that is on or off, or the like.

In a non-limiting example, a state of the user or other people within the environment can include, without limitation, a state (e.g., home or not home) of the user or other people, a location (e.g., living room, kitchen, driver seat, etc.) of the user or other people, a state (e.g., standing, sitting, dancing, sleeping, etc.) of the user or other people, a relationship (e.g., mother, daughter, friend, sales person, etc.) of the user or other people, or the like.

The A data can include, without limitation, data sets regarding the user of system 100. In a non-limiting example, the A data can include, without limitation, one or more user defined settings or activity of a user. The one or more user defined settings can include, without limitation, one or more user preferences for how the user wants to be treated by the system 105, how the user wants system 105 to treat other people, which responses are provided by system 105, or the like. The activity of the user can include a state of the user as described above. In some cases, the activity of the user can further include an activity (e.g., working, playing, or the like) the user is performing, what people the user is interacting with, or the like. In a non-limiting example, the computing system 105 or the analytics system running on computing system 105 can be told by the user how the computing system 105 or the analytics engine should “feel” toward a user or other people and the user can specify certain criteria such as politeness, discourtesy, grumpiness, helpfulness, etc. Thus, the user can change how the system 105 reacts towards different individuals over time. In another non-limiting example, a user speaking with profanity, manners, curtness, affection, etc. can cause computing system 105 to increase or decrease the Affection value for that given user.

Each of the TEA data is configured to change over time. The T data can be configured to change based on the environment of the user over time or based on a change to other external data over time, the controllable data can be configured to change based on the environment of the user over time or based on changes to other controllable data, and the user data can be configured to change based on user preferences over time or user activity over time or based on other changes to user data over time.

Each of T data, E data, or A data can be applied independently or correlated together using the computing system 105 or the analytics engine of the computing system 105 to determine a current state of the system 100 and a response to use to react or respond to one or more inputs 202a from one or more of the one or more computing systems 105, one or more IoT-capable devices 110 or other devices, one or more IoT-capable sensors or other sensors, one or more devices 120, and one or more databases 125 or the user of one or more computing systems 105, one or more IoT-capable devices 110 or other devices, one or more IoT-capable sensors or other sensors, one or more devices 120, and one or more databases 125.

The response to the input is flexible and can be defined by an associated response database (e.g., database 125, or the like). In other words, one or more responses can be tailored to a user based on a current state of the system 100 or computing system 105 which may contain mood, personality, emotion, inflections of speech, tone, accent, speech pattern, preferred gestures or silent responses (such as locking and unlocking a door or flashing a light). This database of responses is correlated to the current “mood” or current state of the system 100 or computing system 105.

In a non-limiting example, some users may be more comfortable interacting with others who feel the same way they do, so if the user likes balmy weather and sunshine (T data) and are listening to the music (E data), the system state could be configured to have an elevated mood, and responses to one or more inputs can be selected based on the system's predictably elevated mood or personality. In other cases, some users might believe “opposites attract” and want the manner of responses to have more contrast, so the system state might be more curt, reserved, or otherwise less social when the weather is balmy and warm (T data) and they are listening to the music (E data). Thus, responses to one or more inputs can be selected by system 100 based on the more curt, reserved, less social system state. Yet other users may want a completely individual system so user data can be randomized when the system 100 is first set up.

In various cases, the T data can be assigned a T value, the E data can be assigned an E value, and the A data can be assigned an A value. Each of the T value, E value, and A value (collectively referred to as “TEA values”) can change or be correlated over time such that the state of the system and the manner of responses changes over time based on changes to one or more of the TEA data. These changes or correlations over time can create a “biorhythm” or current state for the system 100 such that the manner of responses changes over time as the system 100 interacts with the user, the inputs or data 202a, or one or more of the TEA values are otherwise updated.

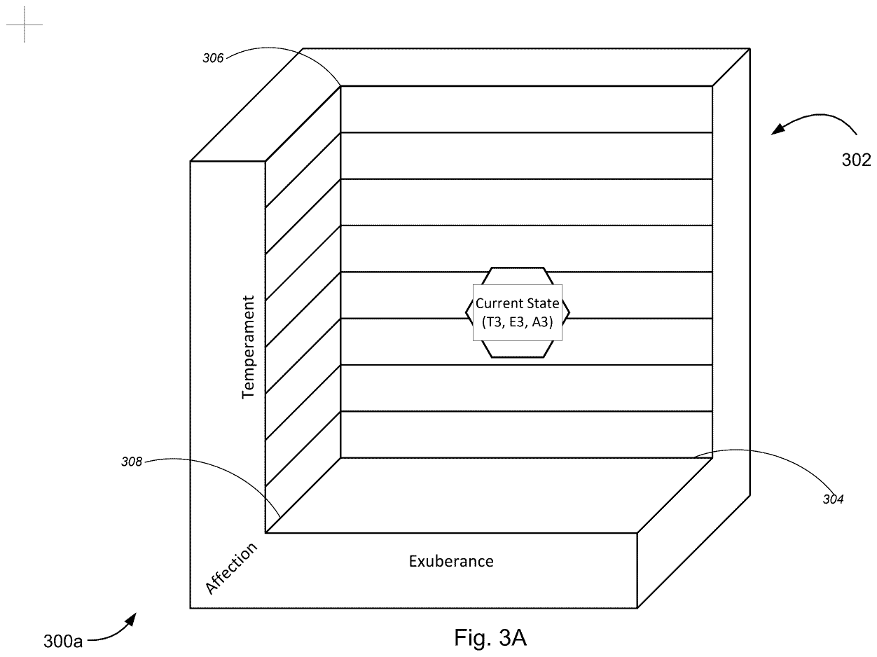

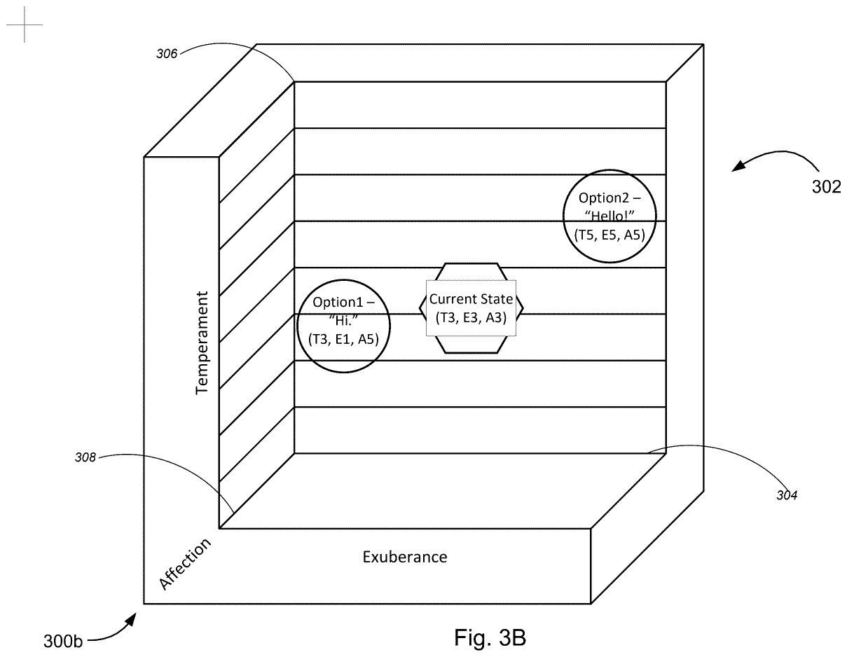

Turning to FIGS. 3A and 3B, FIG. 3A depicts a first graph 300a that depicts an example value of a current state of a system within a virtual space, a mathematical space, array, a multidimensional space, or the like. As shown in FIG. 3, the space is a 3D space or field 302 that can be any size and scale. However, the space should not be limited to only a three-dimensional space and could be any other array or space that is capable of correlating values such as the TEA values.

The example value (e.g., the example TEA value) of the current state is 3, 3, 3 within this space 302. In other words, the example TEA value of 3, 3, 3 reflects how the system (e.g., system 100 or computing system 105) currently “feels” and defines how the system will determine a response to one or more inputs (e.g., inputs 202a or the like).

In various cases, the current TEA value of the current state of the system can be determined when at least one of the one or more TEA values change, at a predetermined time (e.g., every minute, every day, at a specific time every day, or the like), after a predetermined amount of time (e.g., after a minute, after an hour, or the like) has passed, or at the time one or more inputs are received, or the like. Each TEA value can be determined using a different method. For example, in some cases, the T value and the E value can be determined each time the computing system 105 determines the T value and the E value have changed, at a specific time of day, or after a predetermined amount of time has passed while the A value is determined when the one or more inputs are received.

FIG. 3B depicts a second graph 300b used to plot and/or correlate the current TEA values of the current state of the system with a predefined response. Graph 300b can further be associated with one or more inputs (e.g., user inputs, device inputs, or the like) or a category of one or more inputs and can include one or more predefined responses based on a predefined response to the one or more inputs, including sample responses such as “Hi” and “Hello” depicted in the second graph 300b.

Turning first to defining one or more predefined responses based on the one or more potential inputs, the database 125 of system 100 can be configured to store one or more rules or instructions for determining the one or more predefined responses to use to react to one or more potential inputs. In various cases, the one or more predefined responses can be stored in the database 125 based on a category associated with the predefined response or the one or more inputs.

Alternatively, computing system 105 can be configured to determine one or more predefined responses using generative artificial intelligence as described above. In a non-limiting example, computing system 105 can be configured to access a generative artificial intelligence system to determine one or more predefined responses in a “greetings” category and then plot those predefined responses in the second graph 300b.

In various cases, each potential input could be assigned to a category of possible predefined responses to use to respond to each potential input. The category of possible predefined responses could include, without limitation, “greetings,” “farewells,” “introductions,” “device states,” “people states,” “notifications,” etc. It should be noted that these categories of possible predefined responses are not intended to be limiting and other categories of possible predefined responses could be used to describe a plethora of different potential responses.

In a non-limiting example, category “greetings” could include responses “hello,” “hi,” “good morning,” or the like. Category “farewells” could include, without limitation “goodbye,” “bye,” “goodnight,” etc. Category “introductions” could include “my name is,” “how are you today,” “nice to meet you,” etc.

Response categories can further include, without limitation, device states, people states, location of objects or other data. Response category “notifications” can include, for example and without limitation, whether a door or window was left open and one or more corresponding notifications or responses indicating a door was left open, whether a person has overslept and one or more corresponding notifications or responses indicating the person has overslept, or the like.

Each predefined response in each category could then be stored in database 125 in association with scores related to its T data or T value, its E data or E value, and its A data or A value. In other words, each of the one or more predefined responses in each category is stored in association with its TEA value which correspond to the manner or state used to respond to a given input. Database 125 can be modular, with all responses aligning with a certain personality type selected by a user. For example, a user that would like a “Grumpy” system can be configured with a “Grumpy” database that has all replies a little “edgy” while a Spanish-speaking user that would like a “helpful” system can be configured with a “helpful” database entirely in Spanish so that every potential response is available and strikes a certain tone in the user's preferred language.

Each of the one or more predefined responses for each category of predefined responses is assigned a location in a three-dimensional (3D) space based on its TEA value as depicted in FIG. 3B. Additionally, the current state reflecting a current TEA value of the system can be plotted in the 3D space 302 as shown in FIG. 3B. In various instances, a first axis 304 (e.g., an x-axis) of the 3D space 302 can be used to reflect the T data, a second axis 306 (e.g., a y-axis) of the 3D space 302 can be used to reflect the E data, and a third axis 308 (e.g., a z-axis) of the 3D space 302 can be used to reflect the A data.

In various cases, one or more manufacturers, programmers, users, or other people can define one or more numerical values (e.g., TEA values) for each of the one or more predefined responses or the computing system 105 can be configured to automatically assign one or more numerical values to each of the one or more predefined responses based on one or more predefined rules. When the system automatically assigns the numerical values to each of the predefined responses, the system has potential to become a true AI because the system can choose to change itself by writing changes to its own response database. In a non-limiting example, computing system 105 can query a generative artificial intelligence system to determine one or more responses to use to respond to an input. The computing system can then assign the one or more responses an initial TEA value and over time the computing system 105 can choose different responses to try and update the initial TEA value of each response based on feedback (e.g., user input, user interaction, third party feedback, or the like).

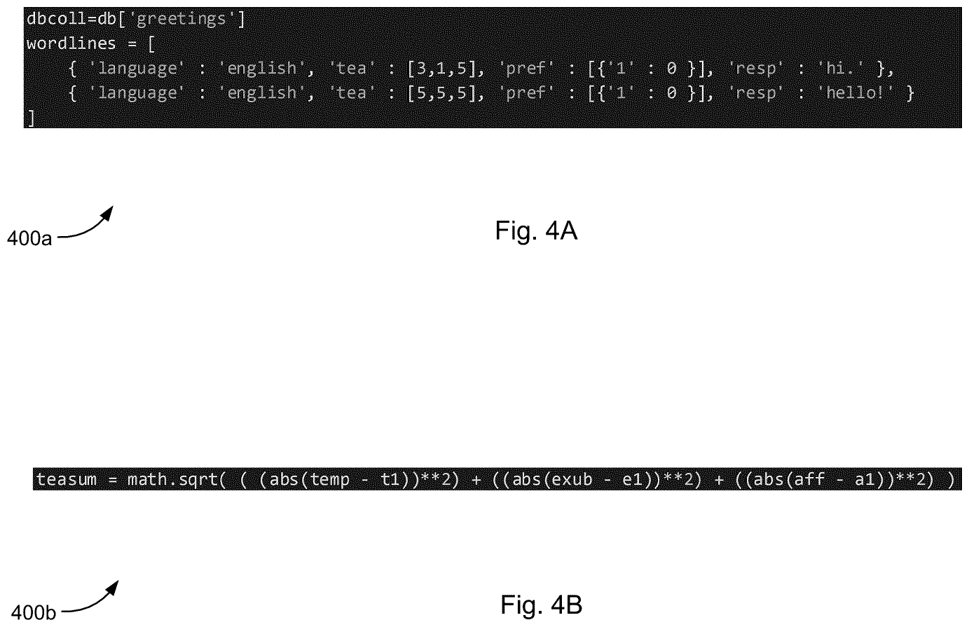

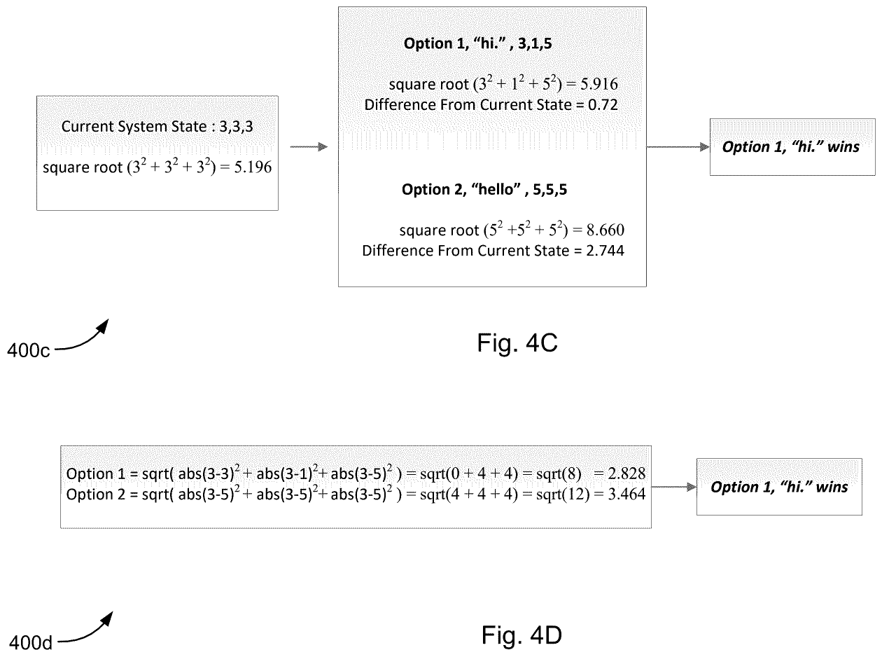

Turning to the non-limiting example of FIGS. 3B and 4A, for the category of “greetings,” responses such as “hi” and “hello” are assigned two different locations (e.g., TEA values) in the 3D space 302. For example, a predefined warm, welcoming “hello” could be assigned a numerical value of (5, 5, 5,) based on its TEA value while a more curt, less welcoming “hi” could be assigned a numerical value of (3, 1, 5) based on its TEA value. Each of these TEA values associated with “hello” and “hi” could be predefined by one or more manufacturers, programmers, users, or other people or automatically by the computing system 105 using one or more predefined rules or a generative artificial intelligence system. These TEA values stored in association with “hello” and “hi” are depicted in the formula or python code 400a shown in FIG. 4A. However, other programming languages or ways to assign values can be used other than those shown in the figures.

By correlating one or more rules or instructions with available responses in a predefined manner, the computing system 105 or the analytics engine of the computing system 105 is thus configured to determine a predictable, consistent manner or response to one or more inputs that is customized to a particular user. In this way, the computing system 105 or the analytics engine can be prevented from hallucinating or responding to the one or more inputs in an unpredictable way. Further, the database can be continuously updated based on user input. For example, if a user does not like certain words, phrases, speech patterns, or the like of a response, the user can tell the computing system 105 or the analytics engine to avoid using those words, phrases, speech patterns, or the like and the database 125 can be updated to remove or avoid responses including those words, phrases, speech patterns, or the like.

In addition, when the database of responses is created using generative AI, users can update or change or provide feedback to update or change the database when a user determines a predefined response does not fit within a category or does not reflect a current TEA value of the system. For example, if a user asks the system “how are you” and the system says “bug off,” a user can report that “bug off” appears to be an incorrect response for the question “how are you” and the database can be updated at the TEA location for “bug off” to provide a more palatable response such as “I feel awful.” In another example, if the current state of the system is cheerful and provides a response that is not cheerful, a user can report that the database does not appear to be cheerful and the database can be updated at the TEA location to provide a more cheerful response. Thus, the database can be consistently updated to provide a predictable, consistent manner or response to one or more inputs by updating the TEA values of the one or more responses. In various cases, these updates could be performed automatically by the computing system 105 or by a technician based on user feedback. For example, if a user indicates that a response was not cheerful when in should have been, the computing system 105 can automatically change (e.g., reduce or increase the probability of that reply's use, or the like) or a technician can manually change the TEA value of the response to reflect that the response is not cheerful.

Turning to determining a current state of the system associated with the one or more inputs, the computing system 105 or the analytics engine of the computing system 105 can first determine the category associated with the one or more inputs. For example, the category could include, as discussed above without limitation, “greetings,” “farewells,” “introductions,” “device states,” “people states,” “notifications,”etc.

Once the category is determined, as the category is being determined, or before the category is determined, the current state of the system can be determined by the computing system. The current state of the system can be predetermined when the one or more TEA values change, can be determined at a predetermined time (e.g., every second, every minute, every hour, every day, at a specific time of day, or the like), can be determined after a predetermined amount of time has passed, can be determined when the one or more inputs are received, or using a combination of one or more of these methods. For example, a T value or an E value can be determined at a predetermined time or when the computing system 105 determines one of these values has changed while an A value can be determined when the one or more inputs are received.

In order to correlate the current state associated with the one or more inputs, each of the T data, the E data, or the A data can be assigned a corresponding TEA value (e.g., at a predetermined time, after a predetermined amount of time, when a value changes, at a time when the inputs are received, or the like) and the current state of the system can then be plotted in the 3D space 302.

In a non-limiting example, T data associated with the current state could indicate a sunny day. T data indicating a sunny day could be assigned a higher numerical value (e.g., a 5 on a scale of 1-5) while snowy weather could be assigned a lower numerical value (e.g., a 1 on a scale of 1-5). If T data from two or more sources (e.g., one or more of computing system 105, IoT devices 110, IoT sensors 115, devices 120, or other sources, or the like) is used, the T data from the two or more sources could each have a different affect on the T value. For example, the two or more sources could be added together, weighted, averaged, averaged based on other factors, or combined, blended, or mixed together using other factors or methods. In a non-limiting example, if the T data associated with the current state is influenced based on type of weather and time of year, then the numerical values associated with the type of weather and time of year could be averaged or weighted and then averaged. In other words, if the type of weather is sunny (e.g., a 5 on a scale of 1-5) and the time of year is spring (e.g., a 4 on a scale of 1-5), then the average numerical value assigned to the T data could be 4.5 or the weighted average numerical value assigned to the T data could be 4.67 (if the type of weather is twice as important as the time of year). Each of the weights could be customizable to a particular user or the like.

Similar processes could be used to assign numerical values to the E data associated with the current state. In a non-limiting example, E data associated with the current state could indicate that pop music is playing. E data indicating pop music could be assigned a higher numerical value (e.g., a 5 on a scale of 1-5) while blues or other music could be assigned a lower numerical value (e.g., a 1 on a scale of 1-5). If E data from two or more sources is used, the E data from the two or more sources could be added together, weighted, averaged, or averaged based on different factors. In a non-limiting example, if the E data associated with the current state is influenced based on type of music playing and whether a user is alone or with other people, then the numerical values associated with type of music playing and whether the user is alone could be averaged or weighted and then averaged. In other words, if the type of music is pop (e.g., a 5 on a scale of 1-5) and the user is alone (e.g., a 1 on a scale of 1-5), then the average numerical value assigned to the E data could be 3 or the weighted average numerical value assigned to the exuberance data could be 2.33 (if whether the user is alone is twice as important as the type of music playing). Each of the weights could be customizable to a particular user or the like.

Similar processes could be used to assign numerical values to the A data associated with the current state. In a non-limiting example, A data is affected with each input or interaction from the user of the system or other external inputs (e.g., similar to the inputs associated with the T data such as weather, or the like) to the system and compares said input or interaction against a “personality” database of the system. If the personality of the system is dour and pessimistic then the user interacting with the system with cheerful language or cheerful music would reduce the A value (e.g., a 1 on a scale of 1-5). Additionally, warm weather or other external inputs could reduce the A value if the personality of the system is dour and pessimistic. If the “personality” database of the system is more optimistic and the user's positive speech reflects optimism or the weather is warm, it can positively affect the A value. If A data from two or more sources is used (such as negative speech as well as the slamming of a door), the numerical value for the A data from the two or more sources could be averaged or weighted and averaged based on different factors as described above.

In some cases, each of the TEA values of the current system state can be affected or influenced by another of the TEA values or data creating or generating an interplay or rhythm between data elements (“biorhythmic interplay”) among the TEA data or TEA values of the current state of the system over time. For example, a T value of the current system state could be influenced positively, negatively, increase, or decrease based in part on at least one of the controllable E data or the user A data, an E value of the current system state could be influenced positively, negatively, increase, or decrease based in part on at least one of the external T data or the user A data, or an A value of the current system state could be influenced positively, negatively, increase, or decrease based in part on at least one of the external T data or the controllable E data. These influences can be configured to change, increase, or decrease over a predetermined amount of time in response to the one or more inputs or changes to each of the TEA data.

In a non-limiting example, consistently high affection or A values over time can influence exuberance or E values over time, changes to exuberance or E values can influence temperament or T values, and the like. In a non-limiting example, if a user is home for over a week (E data), then, even if it is raining outside (T data) which the computer doesn't “like”, the T value will remain higher than if the user hadn't been home all week despite the fact that it is raining. As another non-limiting example, if the computing system 105 detects that a user has been out of the premises for a week (E data), the computer being left alone in an empty house will affect the current state and cause the computing system to reduce the T value even if it is sunny outside and the computer “likes” sunny days. This interplay of T, E and A values allows for more “human” responses over time, and the duration of said interplay can be configurable administratively.

In another non-limiting example, TEA data can directly or indirectly affect another of the TEA values. For example, A data can affect the T value which in turn affects the E value. In other words, A data can indirectly affect the E value through the T value. For example, any A data could cause the T value to change over time, which over time causes the E value to change. For example, consider a situation where a baseline of the system is at a specific TEA value, the A value is reduced by 1 because the system determines the user has people visiting the house the user does not prefer. The trend in the A value continues for several hours because the user is still meeting with the people that the user does not prefer. This forms a trend, causing the T value to also be reduced by −1. By the end of the day the T value has also formed a trend based on the A value and, the E value is also reduced because of the trend in the T value. Thus, by the end of the day, the overall TEA value of the system is low because the TEA value of the system has been affected by other people the user has been with all day. Once the people the user does not prefer are no longer in the house, the A value can increase over time which can then cause the T value to increase. The T value can then cause the E value to increase over time. In this way, a rhythm or biorhythm is formed in the system causing the system to emulate human emotions, moods, responses, etc.

Once a numerical value for each of the TEA data is determined, a current state associated with the TEA values can plotted in the 3D space 302 associated with the category of the one or more inputs.

The current state plotted in the 3D space 302 can then be compared to or correlated with one or more predefined responses already plotted in the 3D space for a given input or response or category of inputs or responses. The computing system 105 or analytics engine of the computing system 105 can then be configured to select the predefined response to use to respond to the one or more inputs based on the correlation of the current state to the predefined responses. The selected predefined response can be a predefined response that is closest to the location associated with the current TEA value of the current state in the 3D space 302.

In a non-limiting example, as shown in FIGS. 3B and 4B, in order to select a predefined response that is closest to the current state associated with the one or more inputs, the computing system 105 or the analytics engine of the computing system 105 can utilize one or more mathematical formulas 400b that correlate or compare the current location 310 of the current state and one or more predefined locations of one or more predefined manners or predefined responses to select predefined response that is closest to current state associated with the one or more inputs.

In a non-limiting example, as shown in FIG. 3B, the computing system 105 or the analytics engine of the computing system 105 can first determine a category of the one or more inputs. In the case of FIG. 3B, the category of the one or more inputs is “greetings.” This category can be determined based on a user saying a greeting (e.g., “hello,” “hi,” “Welcome home,” etc.) to the computing system 105 or the analytics engine. Alternatively, this category can be determined by the computing system 105 or the analytics engine of the computing system 105 based on one or more other inputs (e.g., a user arriving home, a user entering a vehicle, a door of a house opening, detection of motion at an entrance of a house, or the like).

Once the category is determined, while the category is being determined, or before the category is determined, a current state of the system can be determined by the computing system 105 or the analytics engine of the computing system 105 based on the current TEA values. As stated before, these TEA values can be predetermined, determined when a change in the TEA values is detected, or determined when the one or more inputs are received, or determined using one or more of these methods, or the like. The current TEA values of the current state can then be related to the categorical response list (e.g., one or more predetermined responses associated with one or more inputs). In the non-limiting example of FIG. 3B, the computing system 105 or the analytics engine of the computing system 105 can determine that the TEA value of the current state is of the system is (3, 3, 3).

Once the category associated with the one or more inputs and the TEA value of the current state are determined, the computing system 105 or the analytics engine can then compare the current state (TEA values 3, 3, and 3 respectively) to one or more predefined responses. In the non-limiting example of FIGS. 3B and 4B, for the “greetings” category, the first predefined greeting “Hello” has been assigned a 5 for each of the TEA values while the second predefined greeting “Hi” has been assigned TEA values of 3, 1, and 5 respectively.

The current state TEA location (3, 3, 3) can then be compared or correlated to the first predefined greeting (5, 5, 5) and the second predefined greeting (3, 1, 5) to determine which predefined response TEA value is closest to the current state TEA value. This comparison or correlation can be performed by applying a permutation of the Pythagorean Theorem such as an L2 Norm/Euclidean Distance, Chebyshev Distance, Minkowski distance or Mahalanobis Distance, or other computation methods, within said 3D space or other space in a way that provides a single, comparable score, and the lowest score—being the smallest difference or closest score—is selected as the predefined response to use to respond to the one or more inputs.

FIG. 4B reflects one way to compare the current state TEA value to one or more predefined greetings in the 3D space 302. However, other methods are possible and within the scope of this disclosure. In a non-limiting example and as shown in FIG. 4B, every predefined response can be compared to the current state of the system by taking the absolute difference between each of the TEA values for the current state and each of the predefined response available, squaring these differences, adding the squared differences together, and then taking the square root of the sum (L2 Norm).

In a non-limiting example, FIG. 4C shows a “long way” of comparing TEA values and determining nearest-scores. The current system state of 3, 3, 3 is run through an iteration of the equation 400c to obtain a score of 5.196. Option 1 and option 2 are run through the same equation to obtain scores of 5.916 and 8.660, respectively. The difference between the current state and option 1 is 0.72 while the difference between the current state and option 2 is 2.744. This demonstrates that Option 1 has the lowest difference of 0.72, it is selected by the computing system as the response to provide to the one or more inputs.

FIG. 4D shows another example of the application of potential equation 4B, whereby Option 1's TEA values are directly subtracted from the current state TEA values, squared, added together and its sum square rooted to provide single scores, otherwise known as an L2 Norm. Whichever available responses single score is the lowest is then selected as the provided response (e.g., option 1). This application is programmatically easier in that every potential option within a Category is evaluated, and whichever value is lowest is selected.

Given FIG. 4D and based on the determination that 2.828 is less than 3.464, the computing system 105 or the analytics engine of the computing system 105 can then select the more curt, less friendly “hi” as the predefined response to use to respond to one or more inputs in the greetings category. In other words, the more curt, less friendly predefined “hi” is closest to current state of the computing system (system state) or how the computing system presently “feels” towards a user of the computing system 105.

In this way, one or more users or other individuals can interact with a personalized computing system that reflects a response based on the current state of the system that exists when one or more inputs are received. In this way, the computing system 105 or analytics engine can adapt or change the response it uses to respond over time such that a user is not always interacting with a computing system that sounds the same all the time, but in fact has simulated “feelings” to convey. The computing system 105 can be configured to sound happy, sad, indifferent, curt, friendly, snarky, young, old, or the like using the T data, the E data, and the A data that is predetermined or that exists when one or more inputs are received. Thus, users of the computing system 105 or analytics engine of the computing system 105 can always receive a personalized experience that is tailored to them and yet is difficult to predict over time.

Additionally, by storing one or more predefined responses in database 125 and only allowing the computing system 105 or analytics engine of the computing system 105 to use those predefined responses, the computing system 105 or analytics engine of the computing system 105 is prevented from generating false information or responding to one or more user inputs in an unpredictable or inconsistent way. Thus, one or more users can expect the computing system 105 or analytics engine of the computing system 105 to provide consistent reliable responses to the one or more inputs. In some cases, the one or more predefined response databases 125 can be used to train one or more AI models such that the AI models are able to provide more consistent and “emotional” responses in the future.

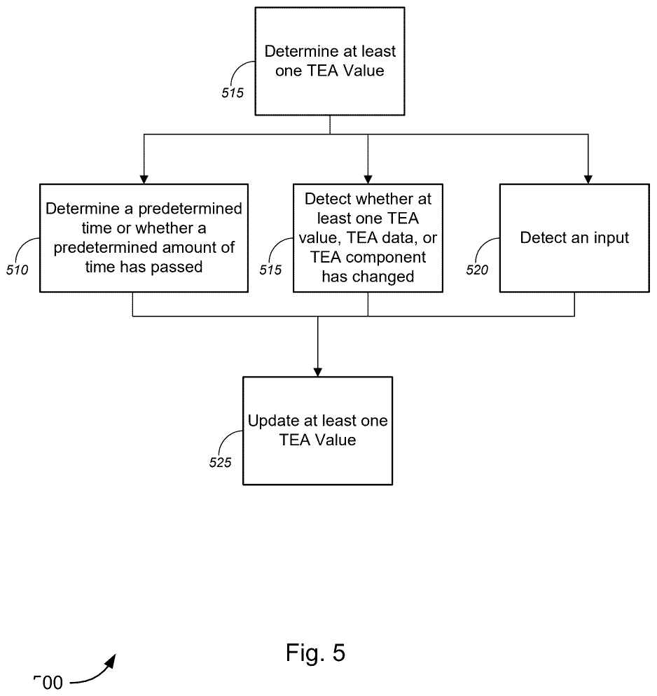

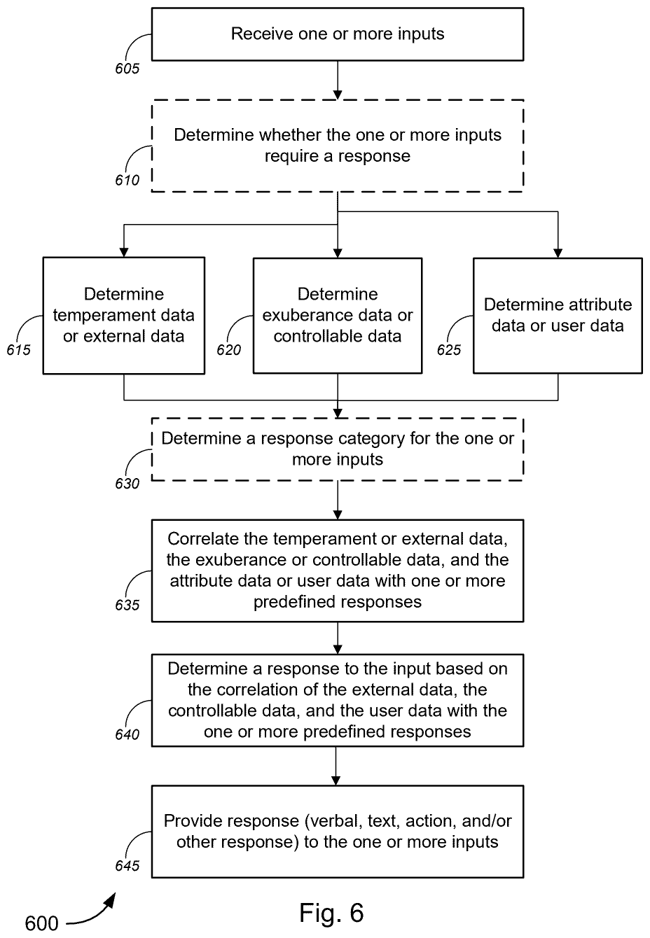

FIGS. 5 and 6 are flow diagrams for implementing the emulation system to determine a response to one or more user inputs, in accordance with various embodiments.

While the techniques and procedures are depicted or described in a certain order for purposes of illustration, it should be appreciated that certain procedures may be reordered or omitted within the scope of various embodiments. Moreover, while the methods 500 and 600 illustrated by FIGS. 5 and 6 can be implemented by or with (and, in some cases, are described below with respect to) the systems, examples, or embodiments 100, 200, 300, and 400 of FIGS. 1, 2, 3, and 4, respectively (or components thereof), such methods may also be implemented using any suitable hardware (or software) implementation. Similarly, while each of the systems, examples, or embodiments 100, 200, 300, and 400 of FIGS. 1, 2, 3, and 4, respectively, (or components thereof), can operate according to the methods 500-and 600 illustrated by FIGS. 5 and 6 (e.g., by executing instructions embodied on a computer readable medium), the systems, examples, or embodiments 100, 200, 300, and 400 of FIGS. 1, 2, 3, and 4 can each also operate according to other modes of operation or perform other suitable procedures.

In the non-limiting embodiment of FIG. 5, method 500 illustrates a method to determine TEA values of a current state of the system.

Method 500 at block 505 can include determining a TEA value of a current system state. For example, in order to determine a TEA value of the current system state, a current T value of the current state is determined based on the T data described above, a current E value of the current state is determined based on the E data described above, and a current A value of the current state is determined based on the A data described above. In order to determine the current TEA value of the current system state, a computing system could use one or more of the following options.

For example, the computing system could determine the TEA value of the current state at a predetermined time (e.g., 8:00 AM, 12:00 PM, in the morning, afternoon, or the like) or after a predetermined amount of time (e.g., 1 second, 1 minute, 5 minutes, 1 hour, or the like) has passed (optional block 510). In this way, the TEA value of the current state could be updated throughout a day or at a specific time and change based on the data analyzed at the predetermined time or after the predetermined amount of time has passed.

In some cases, the computing system could determine the TEA value of the current state based on a detection that the data associated with each TEA value has changed (optional block 515). For example, based on a detection that it is now cloudy instead of sunny, the T value could be updated or, based on a determination that a user has arrived home, the E value could be updated. In this way, the TEA value of the current state could change dynamically (e.g., in real-time or the like) throughout a day based on a detection of a change in the one or more of the TEA data.

In some cases, the computing system could determine the TEA value of the current state based on a detection of one or more inputs or user interactions (optional block 520). For example, based on a detection of one or more inputs requiring a response, the computing system could be configured to determine a current TEA value of the current state of the system. Alternatively, based on a user interaction (e.g., update of user settings or preferences, user or third party communicating with the system, or the like) with the system, one or more of the TEA values could be updated. In this way, the TEA value of the current state could update to the most current state when the computing system determines a response to one or more inputs is required.

Method 500 can then proceed to block 525 and update the TEA value of the current state based on one or more determinations of the predetermined time or after the predetermined time has passed, a detection that at least one TEA value has changed, or a detection of an input. In various cases, the current TEA value of the current state of the system can be written to database 125 to be used when one or more inputs are received.

In various cases, each of the T value, the E value, or the A value can be updated using different options. In a non-limiting example, the T value could be updated at a predetermined time, the E value could be updated at upon detection that the E data has changed, and the A value can be updated based on detection of an input. Alternatively, in other cases, some values could be updated using a same option while another is updated using different options. For example, the T value and E value could be updated after a predetermined amount of time has passed while the A value is updated when an input is received. Alternatively, in other cases, the TEA values could be updated using the same option. For example, the TEA values could be updated when the input is received.

Turning to method 600, method 600 is a method that can be used to determine a predetermined response to use based on the current state of the system when one or more inputs are received.

Method 600, at block 605, might comprise receiving, with a computing system, one or more inputs. The one or more inputs could include, without limitation, one or more user inputs, one or more third party inputs, one or more device inputs, one or more sensor inputs, one or more environmental inputs, or the like. The one or more user or third party inputs could include, without limitation, a user or person speaking to the computing system, detection of a presence of a user or person in a particular location (e.g., arriving home, in the living room, in the car, or the like), detection of motion of a user or person, detection of an unfamiliar user or person, detection of a user or person interacting with one or more devices, or the like. The one or more device inputs could include, without limitation, one or more device states (e.g., open, closed, on, off, locked, unlocked, in use, not in use, or the like), one or more device types, information of a device, or the like. The one or more environmental inputs could include, without limitation, a determination of time of day, time of year, time of week, season, weather, or the like.

The method 600, at optional block 610, can further include determining based on the one or more inputs, whether the one or more inputs require a response (e.g., a response, a notification, or the like) to a user of the computing system. In a non-limiting example, if the computing system determines that one or more doors are locked and it is bedtime, then a response or notification might not be needed. However, if the computing system determines that one or more doors are unlocked and it is bedtime, then a response or notification might be needed to let a user or another person know that the house has not been locked for the night or that a door has been opened while asleep.

The method 600 can include, at block 615, determining, with the computing system, T data or a T value associated with an environment of a user, at block 620, determining, with the computing system, E data associated with the environment of the user, and, at block 625, determining, with the computing system, A data associated with the user. In various cases, the TEA data or TEA values that are determined by the computing system represent a current TEA value of a current system state.

The determination steps 615-625 can occur in parallel or sequentially and/or before or after the one or more inputs are received. For example, the TEA value of the current state of the system can be determined at a predetermined time, after a predetermined amount of time has passed, upon detection that at least one TEA value has changed, or upon a detection of the one or more inputs, or the like. In some cases, the T value and the E value are determined before the one or more inputs are received.

The T data, the E data, or the A data can be determined using one or more inputs, data, or equations described above with respect to FIGS. 1-4. In various cases, the T data or the E data can be associated with an environment of the user while the A data can be associated with a user, the settings of a particular user, manufacturer, programmer, or the like. In some cases, the T data can be associated with one or more inputs or data that are outside the control of the user, manufacturer, programmer, or the like while the E data can be more controllable by the user, manufacturer, programmer, or the like.

Once the T data or the T value, the E data or the E value, or the A data or the A value is determined, the method 600, at block 630, can optionally include at block 630, determining a response category for the one or more inputs. In a non-limiting example, the response category could include, without limitation, “greetings,” “farewells,” “introductions,” “device states,” “people states,” “notifications,” etc.

Next, method 600, at block 635, can include correlating, with the computing system, the TEA data or TEA value with one or more predefined responses in the determined response category. The determined TEA data or value can represent a current state of the system and can be assigned a current TEA value representing the current system state. In order to correlate the TEA values, similar methods could be used as described with respect to FIGS. 3 and 4.

For example, in order to correlate the TEA values, a current state TEA value can be determined using the T data, the E data, or the A data. Once the TEA value for the current state is determined, the current state could be compared to two or more predefined responses in a response category associated with the one or more inputs. This comparison could be made using a 3D space as discussed above or another comparison method could be used.

Once the T data, the E data, or the A data is correlated, the method, at block 640, could include determining, with the computing system, a response to provide to the input based on the correlation of the T data, the E data, and the A data with the two or more predefined responses. In order to determine the response to use given one or more inputs, the computing system could determine a location of the TEA value of the current state in a 3D space and locations of one or more predefined manners in the 3D space as described above with respect to FIGS. 3 and 4. Next, based on the location of the TEA value of the current state in the 3D space and the locations of one or more predefined responses in the 3D space, the computing system could determine a predefined response that is closest to the current state in the 3D space and select the predefined response that is closest to the current state in the 3D space.

Once the response is determined, the method 600 can include, at block 645, responding, with the computing system, to the one or more input using the determined response (e.g., the selected predefined response or the like). In other words, the selected predefined response that is closest to the TEA value of the current state of the system in the 3D space can be used to respond to the one or more inputs.

While certain features and aspects have been described with respect to exemplary embodiments, one skilled in the art will recognize that numerous modifications are possible. For example, the methods and processes described herein may be implemented using hardware components, software components, or any combination thereof. Additionally, more or fewer datapoints or elements could be considered; T, E and A data are described herein but it could be reduced to T and A, or expanded to multiple additional elements. Further, while various methods and processes described herein may be described with respect to particular structural or functional components for ease of description, methods provided by various embodiments are not limited to any particular structural or functional architecture but instead can be implemented on any suitable hardware, firmware or software configuration. Similarly, while certain functionality is ascribed to certain system components, unless the context dictates otherwise, this functionality can be distributed among various other system components in accordance with the several embodiments. Lastly, rather than strictly verbal replies or triggering of an IoT device, physical responses such as shaking one's head or waving a hand can be used instead of or in conjunction with verbal replies or triggering of an IoT device. For example physical responses could be implemented by an android, robot, or other automated device.

Moreover, while the procedures of the methods and processes described herein are described in a particular order for ease of description, unless the context dictates otherwise, various procedures may be reordered, added, or omitted in accordance with various embodiments. Moreover, the procedures described with respect to one method or process may be incorporated within other described methods or processes; likewise, system components described according to a particular structural architecture or with respect to one system may be organized in alternative structural architectures or incorporated within other described systems. Hence, while various embodiments are described with—or without—certain features for ease of description and to illustrate exemplary aspects of those embodiments, the various components or features described herein with respect to a particular embodiment can be substituted, added or subtracted from among other described embodiments, unless the context dictates otherwise.

Consequently, although several exemplary embodiments are described above, it will be appreciated that the invention is intended to cover all modifications and equivalents within the scope of the following claims.

What is claimed is:

1. A method comprising:
receiving, with a computing system, an input;
determining, with the computing system, external data associated with an environment of a user;
determining, with the computing system, controllable data associated with the environment of the user;
determining, with the computing system, user data associated with the user;
correlating, with the computing system, the external data, the controllable data, and the user data with one or more predefined responses;
determining, with the computing system, a response to the input based on the correlation of the external data, the controllable data, and the user data with the one or more predefined responses; and
responding, with the computing system, to the input using the response.

2. The method of claim 1, wherein correlating, with the computing system, the external data, the controllable data, and the user data with the one or more predefined responses comprises:
assigning, with the computing system, the external data, the controllable data, and the user data to a first location in a space; and
assigning, with the computing system, the one or more predefined responses to a corresponding location in the space; and
wherein determining the response to the input based on the correlation of the external data, the controllable data, and the user data with the one or more predefined responses comprises:
selecting, with the computing system, the response having the corresponding location located closest to the first location associated with the external data, the controllable data, and the user data in the space.

3. The method of claim 2, wherein the space is a three-dimensional space, and wherein the external data is associated with a first axis, the controllable data is associated with a second axis, and the user data is associated with a third axis in the three-dimensional space.

4. The method of claim 1, wherein the external data comprises at least one of weather of the environment, temperature of the environment, humidity of the environment, air quality of the environment, time of day, day of week, time of year, or season of year, wherein the controllable data comprises at least one of a first state of one or more devices within the environment or a second state of the user or other people, wherein the user data comprises user settings or user activity.

5. The method of claim 1, wherein at least one of the external data, the controllable data, or the user data is configured to change over time.

6. The method of claim 5, wherein the external data is configured to change based on the environment of the user over time, the controllable data is configured to change based on the environment of the user over time, and the user data is configured to change based on user preferences over time or user activity over time.

7. The method of claim 1, wherein correlating the external data, the controllable data, and the user data with the one or more predefined responses comprises:
generating a relationship between each of the external data, the controllable data, and the user data.

8. The method of claim 7, wherein generating the relationship between each of the external data, the controllable data, and the user data comprises:
determining, with the computing system, a first value of the external data based in part on at least one of the controllable data or the user data;
determining, with the computing system, a second value of the controllable data based in part on at least one of the external data or the user data; and
determining, with the computing system, a third value of the user data based in part on at least one of the external data or the controllable data.

9. The method of claim 8, wherein the first value, the second value, and the third value are configured to change over a predetermined amount of time.

10. The method of claim 9, wherein the external data is configured to change based on the environment of the user over time, the controllable data is configured to change based on the environment of the user over time, and the user data is configured to change based on user preferences over time or user activity over time.

11. The method of claim 1, wherein at least one first source of one or more of the external data, the controllable data, and the user data is configured to have a different affect than at least one other source of one or more of the external data, the controllable data, and the user data.

12. The method of claim 1, wherein the computing system is a local computing system contained within a premises of the user or a vehicle of the user.

13. The method of claim 12, wherein the one or more predefined responses to respond to the input are stored in a database.

14. The method of claim 1, wherein the external data is determined at a first predetermined time, after a first predetermined amount of time has passed, or upon detection that the external data has changed, wherein the controllable data is determined at a second predetermined time, after a second predetermined amount of time has passed, or upon detection that the controllable data has changed, and wherein the user data is determined when the input is received or when a user interaction is received.

15. The method of claim 1, wherein correlating the external data, the controllable data, and the user data with of the one or more predefined responses and determining a response to the input based on the correlation of the external data, the controllable data, and the user data with the one or more predefined responses is based on one or more rules stored in a database of the computing system.

16. The method of claim 1, wherein the one or more predefined responses are determined by the computing system querying a generative artificial intelligence system for example responses based on the input, and wherein the computing system assigns each example response a corresponding location in a mathematical space.

17. The method of claim 16, wherein the computing system updates the corresponding location of each example response over time based on feedback received regarding each response.

18. An apparatus, comprising:
a processor; and
a non-transitory computer readable medium communicatively coupled to the processor, the non-transitory computer readable medium having stored thereon computer software comprising a set of instructions that, when executed by the processor, causes the apparatus to:
receive an input;
determine external data associated with an environment of a user;
determine controllable data associated with the environment of the user;
determine user data associated with the user;
correlate the external data, the controllable data, and the user data with one or more predefined responses;
determine a response to the input based on the correlation of the external data, the controllable data, and the user data with the one or more predefined responses; and
respond to the input using a predefined response of the one or more predefined responses.

19. The apparatus of claim 18, wherein correlating the external data, the controllable data, and the user data with the one or more predefined responses comprises:
assigning the external data, the controllable data, and the user data to a first location in a three-dimensional space; and
assigning each of the one or more predefined responses to a corresponding location in the three-dimensional space; and
wherein determining the response to the input based on the correlation of the external data, the controllable data, and the user data with the one or more predefined responses comprises:
selecting the response having the corresponding location located closest to the first location associated with the external data, the controllable data, and the user data in the three-dimensional space.

20. A system, comprising:
at least one of one or more sensors or one or more user devices; and
a computing system communicatively coupled to at least one of the one or more sensors or one or more user devices, the computing system comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive an input from at least one of the one or more sensors or the one or more user devices;
determine external data associated with an environment of a user;
determine controllable data associated with the environment of the user;
determine user data associated with the user;
correlate the external data, the controllable data, and the user data with one or more predefined responses;
determine a response to the input based on the correlation of the external data, the controllable data, and the user data with the one or more predefined responses; and
respond to the input based using a predefined response of the one or more predefined responses.
